(19) United States
(12) Patent Application Publication
(10) Pub. No.: US 2026/0331381 A1
(43) Pub. Date: Oct. 22, 2026

(54) CAPACITOR ASSEMBLY COMPRISING A CAPACITOR ELEMENT WHICH HAS A FIRST CAPACITOR AND A SECOND CAPACITOR

(71) Applicant: Robert Bosch GmbH, Stuttgart (DE)

(72) Inventor: Jan Allgeier, Karlsruhe (DE)

(21) Appl. No.: 19/479,887

(22) PCT Filed: Apr. 29, 2024
(86) PCT No.: PCT/EP2024/061725

§ 371 Date: Oct. 29, 2025

(30) Foreign Application Priority Data
May 9, 2023 (DE) 10 2023 204 267.3

(51) Int. Cl. H01G 4/38; H01G 4/232; H01G 4/30

(52) U.S. Cl. CPC H01G 4/38; H01G 4/232; H01G 4/30

(57) ABSTRACT

The present invention relates to a capacitor assembly (1) comprising a capacitor element (2), which comprises a first capacitor (3) and a second capacitor (4). The first capacitor (3) and the second capacitor (4) each have a layered or wound structure, wherein one first electrode each can be contacted via a first contact element on a first side of each capacitor (3, 4), wherein one second electrode each can be contacted via a second contact element on a second side of each capacitor (3, 4), wherein the first contact element (7) of the first capacitor (3) and the first contact element (7′) of the second capacitor (4) are located on a common side of the capacitor assembly (1) corresponding to the first side, wherein the second contact element (8) of the first capacitor (3) and the second contact element (8′) of the second capacitor (4) are located on a common side of the capacitor assembly (1) corresponding to the second side, and wherein the second contact element (8) of the first capacitor (3) is electrically conductively connected to the second contact element (8′) of the second capacitor (4).

### BACKGROUND

The present invention relates to a capacitor assembly comprising a capacitor element which has a first capacitor and a second capacitor.

For several years, ceramic capacitors have been available under the name LIGA with an extremely low inductance value. These capacitors are optimally suited as buffers for extremely dynamic loads, e.g. as arise when supplying CPUs and GPUs. The underlying concept locates the two electrodes in a layered manner. However, unlike with classical MLCCs, a single-sided, alternating circuit arrangement is selected. The electrodes tech conduct the current in opposite directions. This particular type of circuit largely compensates for the magnetic field and thus sharply reduces the effective inductance. However, the concept cannot be transferred 1:1 to the area of power electronics, because the working voltages and working currents are significantly higher, in particular at vehicle or network level.

### SUMMARY

The capacitor assembly according to the present invention comprises a capacitor element, which comprises a first capacitor and a second capacitor, wherein the first capacitor and the second capacitor each have a layered or wound structure, wherein one first electrode each can be contacted via a first contact element on a first side of each capacitor, wherein one second electrode each can be contacted via a second contact element on a second side of each capacitor, wherein the first contact element of the first capacitor and the first contact element of the second capacitor are located on a common side of the capacitor assembly corresponding to the first side, wherein the second contact element of the first capacitor and the second contact element of the second capacitor are located on a common side of the capacitor assembly corresponding to the second side, and wherein the second contact element of the first capacitor is electrically conductively connected to the second contact element of the second capacitor.

The capacitor assembly in particular creates a DC link capacitor that has a particularly low inductance structure. The structure according to the invention preferably allows the integration of low inductive center tapping via the second contact elements of the two capacitors. The capacitor assembly according to the invention is thus particularly suitable for circuit topologies in which center tapping of the DC link circuit is required, e.g. for T-type inverters.

The first capacitor and the second capacitor optionally have a layered structure. In that case, the first and second capacitors each comprise a plurality of first and second electrode layers. Each of the electrode layers has a plate-shaped structure. The plurality of first electrode layers and the plurality of second electrode layers are alternately layered together. This means that a first electrode layer always rests on a second electrode layer. The electrode layers thereby comprise an insulation in order to avoid a short circuit between the electrode layers on top of one another.

As an alternative to the layered structure, the first capacitor and the second capacitor have a wound structure. In that case, the first and second capacitors typically each comprise first and second electrode layers. Each of the electrode layers is a flexible layer. The two electrode layers are laid together in one manufacturing process and wound together to form multi-ply electrode layers. The electrode layers thereby comprise an insulation in order to avoid a short circuit between the electrode layers on top of one another.

The first contact element of the first capacitor and the first contact element of the second capacitor are located on a common side of the capacitor assembly corresponding to the first side. The second contact element of the first capacitor and the second contact element of the second capacitor are located on a common side of the capacitor assembly corresponding to the second side. Thus, the first contact elements and the second contact elements are on different sides of the capacitor assembly. Thus, voltage jumping between the contact elements may be avoided and the capacitor assembly may be configured for higher operating voltages. This distinguishes it from the concept of LIGA capacitors that have each electrode on the same side.

The second contact element of the first capacitor is electrically conductively connected to the second contact element of the second capacitor. The first and second capacitors may thus form a common capacitance between the first contact elements or may be utilized as two separate capacitances located between the first and second contact elements of the first capacitor and the first and second contact elements of the second capacitor.

The dependent claims disclose preferred further developments of the invention.

Preferably, the first capacitor and the second capacitor each have at least one first electrode layer and a second electrode layer, wherein the first electrode layer protrudes on the first side over the second electrode layer, wherein the second electrode layer protrudes over the first electrode layer on the second side, wherein the first electrode layer is contacted on the first side via a first contact element, which rests on the face of the first electrode layer, and wherein the second electrode layer is contacted on the second side via a second contact element, which rests on the face of the second electrode layer. The first electrode layer protrudes over the second electrode layer on a first side.

For example, in a layered structure of the capacitors, the first electrode layers are sized the same as the second electrode layers and are located such that they are offset from them. In an area where there is no second electrode layer between two successive first electrode layers, the first electrode layers project beyond the second electrode layers. The second electrode layers protrude over the first electrode layers on a second side. For example, the second electrode layers are sized the same as the first electrode layers and are located such that they are offset from them. In an area where there is no first electrode layer between two successive second electrode layers, the second electrode layers project beyond the first electrode layers. The first side is not equal to the second side.

For example, in a wound structure of the capacitors, the first electrode layer is sized the same as the second electrode layer and the two electrode layers are wound such that they are offset from each other. In an area where there is no second electrode layer between two successive first electrode layers in a winding, the second electrode layers project beyond the second electrode layer. Accordingly, the second electrode layer projects over the first electrode layer on the second side. The first side is not equal to the second side.

The first electrode layer or the first electrode layers of a capacitor are contacted on the first side via the first contact element, which rests on the face of the first electrode layer of each of the first electrode layers.

The first electrode layer has opposite surfaces and a circumferential edge. The second electrode layer has opposite surfaces and a circumferential edge. This applies to each of the electrode layers, even if the capacitors have a plurality of first and second electrode layers. At least one of the opposite surfaces of each first electrode layer lies flat on one of the opposite surfaces of a second electrode layer in the case of a layered structure. An end face of the opposite surfaces corresponding to one side of the circumferential edges is one of the remaining sides of the electrode layers that interconnects the opposite surfaces. The first capacitor preferably has a symmetrical structure with respect to the second capacitor.

Preferably, the first electrode layers and the second electrode layers of the layered first capacitor are located parallel to the first electrode layers and the second electrode layers of the second capacitor. This means that the opposite plate surfaces of the electrode layers lie in parallel planes. Further preferably, the first electrode layers and the second electrode layers of the layered first capacitor are preferably located with a maximum deviation of two degrees parallel to the first electrode layers and the second electrode layers of the second capacitor. This means that the opposite plate surfaces of the electrode layers lie in parallel planes.

Preferably, each of the capacitors has the same number of first electrode layers and second electrode layers.

Preferably, the second contact element of the first capacitor is formed in one piece with the second contact element of the second capacitor. Thus, a particularly low resistance is created in the contacts.

Preferably, the capacitor element further comprises a first conductor element located between the first capacitor and the second capacitor connected on the second side to the second contact element of the first capacitor and the second contact element of the second capacitor, and which allows the second contact elements to be contacted on the first side. The first conductor element is preferably formed in one piece with the second contact elements. The first capacitor and the second capacitor are preferably located on the first conductor element or the individual capacitor elements are connected to the conductor via thermally conductive materials. Thus, heat dissipation is enabled by the first conductor element and residual heat is reduced between the first capacitor and the second capacitor. A center point tap is thus created by the first conductor element, wherein all contacts of the capacitor element can be contacted from a common side.

Likewise, preferably, the capacitor element further comprises two second conductor elements located on opposite sides of the first capacitor and the second capacitor, connected on the second side to the second contact elements of the first capacitor and the second contact element of the second capacitor, allowing each of the second contact elements to be contacted on the first side. The two second conductor elements thus surround the capacitor element together with the second contact elements. Preferably, the second conductor elements are formed in one piece with the second contact elements. The first capacitor and the second capacitor are each located on a second conductor element. Thus, heat dissipation is enabled by the second conductor elements. A center point tap is thus created by the second conductor element, wherein all contacts of the capacitor element can be contacted from a common side.

Preferably, the first contact element of the first capacitor is located in a common plane with the first contact element of the second capacitor and/or the second contact element of the first capacitor is located in a common plane with the second contact element of the second capacitor. The common plane is preferably perpendicular to the plane in which the electrode layers of layered capacitors lie or perpendicular to a winding axis in the case of wound capacitors.

Preferably, the first contact element and the second contact elements of the first capacitor are located on opposite sides of the first capacitor, and the first contact elements and the second contact element of the second capacitor are located on opposite side of the second capacitor.

Preferably, the capacitor assembly comprises a plurality of capacitor elements. Thus, the capacitance of the capacitor assembly can be modularly adjusted and the inductance can be reduced simultaneously. Preferably, the second contact elements of all capacitor elements are formed in one piece so that the capacitor assembly has a single contact element comprising all of the second contact elements.

Preferably, the capacitor elements are layered such that the first capacitors and the second capacitors of the capacitor elements are located in alternation. Thus, a particularly uniform current flow is achieved in which the resulting magnetic fields are particularly efficiently mutually offset.

Preferably, the capacitor assembly is configured for an operating voltage of more than 50V. In current systems in electromobility and also in other power electronics, efficient capacitor assemblies are required that have low inductance values, which is made possible by the present invention.

Preferably, the capacitor element has a symmetrical structure, which also causes the resulting magnetic fields to offset each other more efficiently.

In total, a particularly low inductance design is thus enabled in particular by a skillful arrangement of the center point tapping between the divided capacitors provided by the second contact elements, which is thus suitable for applications in power electronics with high power density and high efficiency. A more homogeneous current density in the DC link capacitor or its elements is achieved and thus an increase in the continuous power output.

The gain in efficiency and power density results in particular from the compact design and the low inductance values.

Switching speeds can be increased. The potential of modern semiconductors (SiC, GaN) can thus be better harnessed.

### BRIEF DESCRIPTION OF THE DRAWINGS

In the following, exemplary embodiments of the invention are described in detail with reference to the accompanying drawings. The drawings show:

FIG. 1 a schematic diagram of an exemplary DC link comprising two capacitors,

FIG. 2 a schematic diagram of a capacitor assembly according to the invention,

FIG. 3a to 3d schematic illustrations of different capacitor assemblies according to the invention in a cross-sectional view,

FIG. 4 a schematic illustration of a capacitor assembly with a plurality of capacitor elements according to the invention, and

FIG. 5a to 5c schematic illustrations of different capacitor assemblies according to the invention in a top view.

### DETAILED DESCRIPTION

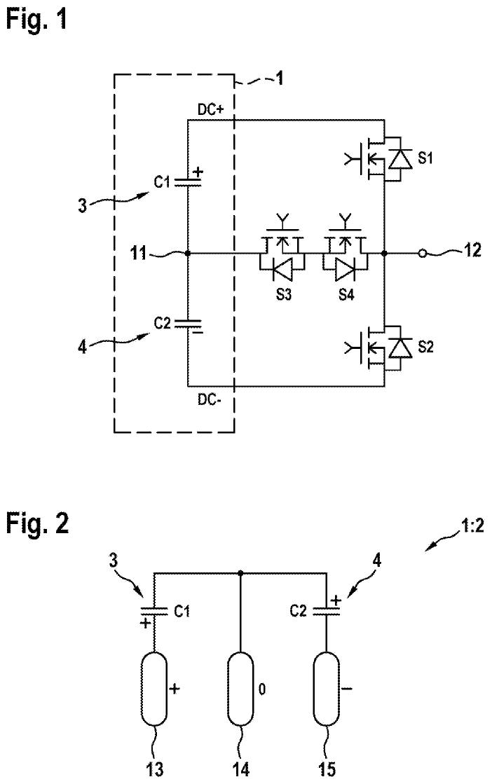

FIG. 1 shows a schematic diagram of an exemplary DC link comprising two capacitors C1, C2. The DC link comprises the two capacitors C1, C2, which can be provided by a capacitor assembly 1 according to the present invention. In this case, capacitors C1 and C2 comprise a first capacitor 3 and a second capacitor 4 of the capacitor assembly 1. In the circuit arrangement shown, the first capacitor 3 and the second capacitor 4 are connected in series, wherein a first contact of the first capacitor is coupled to a positive current bus DC+ and a first contact of the second capacitor 4 is coupled to a negative current bus DC−. The second contacts of the first capacitor 3 and the second capacitor 4 are connected to each other. A center tap 11 is provided between the first capacitor 3 and the second capacitor 4.

A circuit output 12 of the DC link is coupled via a first transistor S1 to the positive DC+ power bus. The circuit output 12 is further coupled to the negative current bus DC− via a second transistor S2. The circuit output 12 is further coupled to the center tap 11 via a third transistor S3 and a fourth transistor S4. By switching the transistors S1 to S4 accordingly, either a positive voltage of the positive current bus DC+, a negative voltage of the negative current bus DC−, or a voltage located between the positive and the negative voltage, which is tapped by means of tap 11, can be provided at the circuit output 12.

The combination of the first capacitor 3 and the second capacitor 4 is also referred to as a DC link capacitor. The DC link capacitor is provided by the capacitor assembly 1, by means of which a particularly low inductance structure is achieved. The structure of the capacitor assembly 1 allows the integration of a low inductive center tap, shown here with the example of a 2-level DC link circuit. The capacitor assembly 1 according to the invention is particularly suitable for circuit topologies in which a center tapping of the DC link is required, e.g. for T-type inverters. The center tap 11 is also referred to as center tapping.

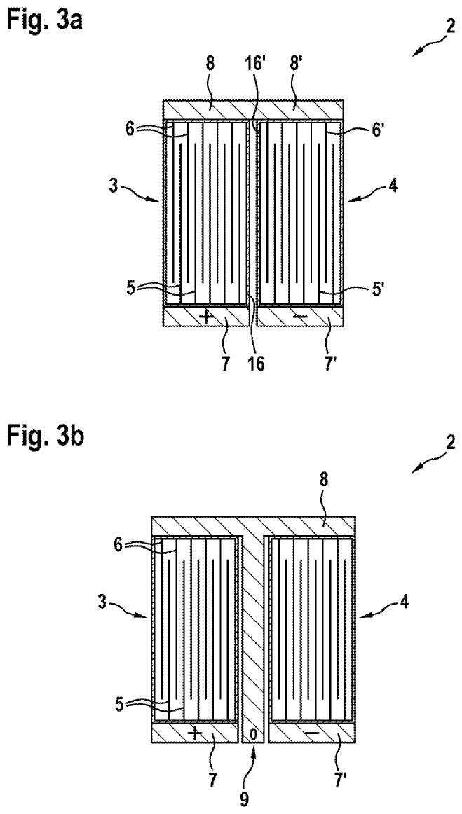

FIG. 2 shows a schematic of a capacitor assembly 1 according to the invention. The capacitor assembly 1 comprises exactly one capacitor element 2. Thus, FIG. 2 also shows a schematic diagram of an exemplary capacitor element 2.

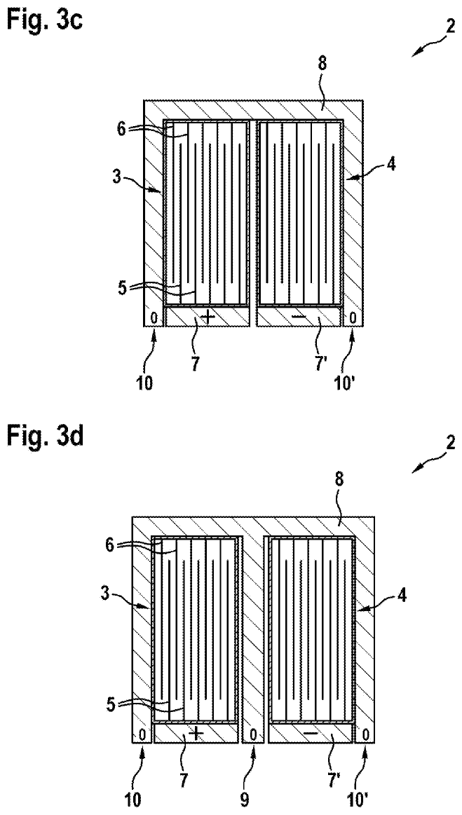

The capacitor element 2 comprises a first terminal contact 13, a second terminal contact 14 and a third terminal contact 15. The first terminal contact 13 is created by a first contact element 7 of the first capacitor 3. The second terminal contact 14 is created by a contacting of a second contact element 8 of the first capacitor 3 and a second contact element 8′ of the second capacitor 4. The third terminal contact 15 is created by a first contact element 7′ of the second capacitor 4. In the circuit shown in FIG. 1, the capacitor assembly 1 is arranged such that the first terminal contact 13 is coupled to the positive current bus DC+, the third terminal contact 15 is coupled to the negative current bus DC−, and the center tap 11 is created by the second terminal contact 14. FIGS. 3a to 3d show exemplary capacitor assemblies 1, each comprising a capacitor element 2. It is noted that the capacitor elements 1, 2 shown in FIGS. 3a to 3d may be combined in any desired manner to form a capacitor assembly 1. The capacitor assemblies 1 shown in FIGS. 3a to 3d are shown in a cross-sectional view. Therefore, the first capacitor 3 and the second capacitor 4 may be understood as either a layered or wound capacitor.

FIG. 3a shows a capacitor element 2 comprising the first capacitor 3 and the second capacitor 4. The capacitor element 2 has a symmetrical structure, wherein a plane of symmetry is located between the first capacitor 3 and the second capacitor 4.

In a first embodiment, the first capacitor 3 has a layered structure. A plurality of first electrode layers 5 of the first capacitor 3 and a plurality of second electrode layers 6 of the first capacitor 3 are alternately layered on top of each other. The first electrode layers 5 of the first capacitor 3 and the second electrode layers 6 of the first capacitor 3 are alternately layered on top of each other. The first electrode layers 5 of the first capacitor 3 and the second electrode layers 6 of the first capacitor 3 are substantially plate-shaped elements, wherein each first electrode layer 5 of the first capacitor 3 rests on a second electrode layer 6 of the first capacitor 3. The first electrode layers 5 of the first capacitor 3 have the same dimension as the second electrode layers 6 of the first capacitor 3. The first electrode layers 5 of the first capacitor 3 project over the second electrode layers 6 of the first capacitor 3 on a first side. The first side is located at the bottom in FIG. 3a. Since the first electrode layers 5 of the first capacitor 3 have the same dimension as the second electrode layers 6 of the first capacitor 3, the second electrode layers 6 of the first capacitor 3 project beyond the first electrode layers 5 of the first capacitor 3 on a second side accordingly, wherein the second side is an opposite side of the electrode layers 5, 6 of the first capacitor 3. The second side is thus located at the top in FIG. 3a. The electrode layers 5, 6 of the first capacitor 3 are either coated or embedded in a casting compound to avoid a short circuit between the first electrode layers 5 of the first capacitor 3 and the second electrode layers 6 of the first capacitor 3. Alternatively or additionally, an insulating element is located between respective adjacent electrode layers 5, 6 of the first capacitor 3 in order to insulate them from one another.

The first electrode layers 5 of the first capacitor 3 are contacted on the first side via a first contact element 7 of the first capacitor 3, which rests on the face of each of the first electrode layers 5 of the first capacitor 3. The end face of the first electrode layers 5 of the first capacitor 3 is respectively the side of the first electrode layers 5, which is located towards the first side, i.e., at the bottom in FIG. 3a. For example, the first contact element 7 of the first capacitor 3 is welded or soldered to the first electrode layers 5. The first contact element 7 thus contacts all first electrode layers 5 of the first capacitor 3. In FIG. 3a, for example, the first contact element 7 of the first capacitor 3 is a positive terminal contact of the capacitor element 2.

The second electrode layers 6 of the first capacitor 3 are contacted on the second side via a second contact element 8, which rests on the face of each of the second electrode layers 6 of the first capacitor 3. The end face of the second electrode layers 6 of the first capacitor 3 is respectively the side of the second electrode layers 5, which is located towards the second side, i.e. at the top in FIG. 3a. For example, the second contact element 8 of the first capacitor 3 is welded or soldered to the second electrode layers 6 of the first capacitor 3. The second contact element 8 of the first capacitor 3 thus contacts all second electrode layers 6 of the first capacitor 3. In FIG. 3a, the second contact element 8 of the first capacitor 3 is, for example, the center tap of the capacitor element 2.

The second capacitor 4 has a structure corresponding to the first capacitor 3, wherein it is optionally configured as a mirror image to the first capacitor 3. The second capacitor 4 thus also has a layered structure. A plurality of first electrode layers 5′ of the second capacitor 4 and a plurality of second electrode layers 6′ of the second capacitor 4 are alternately layered on top of each other. The first electrode layers 5′ of the second capacitor 4 and the second electrode layers 6′ of the second capacitor 4 are alternately layered on top of each other. The first electrode layers 5′ of the second capacitor 4 and the second electrode layers 6′ of the second capacitor 4 are substantially plate-shaped elements, wherein each first electrode layer 5′ of the second capacitor 4 rests on a second electrode layer 6′ of the second capacitor 4. The first electrode layers 5′ of the second capacitor 4 have the same dimension as the second electrode layers 6′ of the second capacitor 4. The first electrode layers 5′ of the second capacitor 4 project over the second electrode layers 6′ of the second capacitor 4 on a first side. The first side is located at the bottom in FIG. 3a. Since the first electrode layers 5′ of the second capacitor 4 have the same dimension as the second electrode layers 6′ of the second capacitor 4, the second electrode layers 6′ of the second capacitor 4 project beyond the first electrode layers 5′ of the second capacitor 4 on a second side accordingly, wherein the second side is an opposite side of the electrode layers 5′, 6′ of the second capacitor 4. The second side is thus located at the top in FIG. 3a. The electrode layers 5′, 6′ of the second capacitor 4 are either coated or embedded in a casting compound to avoid a short circuit between the first electrode layers 5′ of the second capacitor 4 and the second electrode layers 6′ of the second capacitor 4. Alternatively or additionally, an insulating element is located between respective adjacent electrode layers 5′, 6′ of the second capacitor 4 in order to insulate them from one another.

The first electrode layers 5′ of the second capacitor 4 are contacted on the first side via a first contact element 7′ of the second capacitor 4, which rests on the face of each of the first electrode layers 5′ of the second capacitor 4. The end face of the first electrode layers 5′ of the second capacitor 4 is respectively the side of the first electrode layers 5′, which is located towards the first side, i.e., at the bottom in FIG. 3a. For example, the first contact element 7′ of the second capacitor 4 is welded or soldered to the first electrode layers 5′. The first contact element 7′ thus contacts all first electrode layers 5′ of the second capacitor 4. In FIG. 3a, for example, the first contact element 7′ of the second capacitor 4 is a negative terminal contact of the capacitor element 2.

The second electrode layers 6′ of the second capacitor 4 are contacted on the second side via a second contact element 8′, which rests on the face of each of the second electrode layers 6′ of the second capacitor 4. The end face of the second electrode layers 6′ of the second capacitor 4 is respectively the side of the second electrode layer 5′, which is located towards the second side, i.e. at the top in FIG. 3a. For example, the second contact element 8′ of the second capacitor 4 is welded or soldered to the second electrode layers 6′ of the second capacitor 4. The second contact element 8′ of the second capacitor 4 thus contacts all second electrode layers 6 of the second capacitor 4. In FIG. 3a, the second contact element 8′ of the second capacitor 4 is, for example, the center tap of the capacitor element 2.

The first electrode layers 5 and the second electrode layers 6 of the first capacitor 3 are all located in parallel to the first electrode layers 5′ of the second capacitor 4 and the second electrode layers 6′ of the second capacitor 4. Thus, all electrode layers 5, 5′, 6, 6′ of capacitor element 2 are located in parallel but on different planes. The first capacitor 3 is separated and isolated from the second capacitor 4 by an insulation layer 16 of the first capacitor 3 and by an insulation layer 16′ of the second capacitor 4.

In a second embodiment, the first capacitor 3 has a wound structure. A first electrode layer 5 of the first capacitor 3 is wound with a second electrode layer 6 of the first capacitor 3.

The first electrode layer 5 of the first capacitor 3 has the same dimension as the second electrode layer 6 of the first capacitor 3. The first electrode layer 5 of the first capacitor 3 project over the second electrode layer 6 of the first capacitor 3 on a first side. The first side is located at the bottom in FIG. 3a. Since the first electrode layer 5 of the first capacitor 3 has the same dimension as the second electrode layer 6 of the first capacitor 3, the second electrode layer 6 of the first capacitor 3 projects beyond the first electrode layer 5 of the first capacitor 3 on a second side accordingly, wherein the second side is an opposite side of the electrode layers 5, 6 of the first capacitor 3. The second side is thus located at the top in FIG. 3a. The electrode layers 5, 6 of the first capacitor 3 are either coated or embedded in a casting compound to avoid a short circuit between the first electrode layer 5 of the first capacitor 3 and the second electrode layer 6 of the first capacitor 3. Alternatively or additionally, an insulating element is located between the electrode layer 5, 6 of the first capacitor 3 to insulate them from one another.

The first electrode layer 5 of the first capacitor 3 is contacted on the first side via a first contact element 7 of the first capacitor 3, which rests on the face of the first electrode layer 5 of the first capacitor 3. The end face of the first electrode layer 5 of the first capacitor 3 is the side of the first electrode layer 5, which is located towards the first side, i.e. at the bottom in FIG. 3a. For example, the first contact element 7 of the first capacitor 3 is welded or soldered to the first electrode layer 5. In FIG. 3a, for example, the first contact element 7 of the first capacitor 3 is a positive terminal contact of the capacitor element 2.

The second electrode layer 6 of the first capacitor 3 is contacted on the second side via a second contact element 8, which rests on the face of the second electrode layer 6 of the first capacitor 3. The end face of the second electrode layer 6 of the first capacitor 3 is the side of the second electrode layer 5, which is located towards the second side, i.e. at the top in FIG. 3a.

For example, the second contact element 8 of the first capacitor 3 is welded or soldered to the second electrode layer 6 of the first capacitor 3. In FIG. 3a, the second contact element 8 of the first capacitor 3 is, for example, the center tap of the capacitor element 2. The second capacitor 4 has a structure corresponding to the first capacitor 3, wherein it is optionally configured as a mirror image to the first capacitor 3.

The first electrode layer 5′ of the second capacitor 4 is contacted on the first side via a first contact element 7′ of the second capacitor 4, which rests on the face of the first electrode layer 5′ of the second capacitor 4. The end face of the first electrode layer 5′ of the second capacitor 4 is the side of the first electrode layer 5′, which is located towards the first side, i.e., at the bottom in FIG. 3a. For example, the first electrode layer 7′ of the second capacitor 4 is welded or soldered to the first electrode layers 5′. The first electrode layer 7′ contacts the first electrode layer 5′ of the second capacitor 4. In FIG. 3a, for example, the first contact element 7′ of the second capacitor 4 is a negative terminal contact of the capacitor element 2.

The second electrode layer 6′ of the second capacitor 4 is contacted on the second side via a second contact element 8′, which rests on the face of the second electrode layer 6′ of the second capacitor 4. The end face of the second electrode layer 6′ of the second capacitor 4 is the side of the second electrode layer 5′, which is located towards the second side, i.e. at the top in FIG. 3a. For example, the second electrode layer 8′ of the second capacitor 4 is welded or soldered to the second electrode layer 6′ of the second capacitor 4. The second contact element 8′ of the second capacitor 4 contacts the second electrode layer 6 of the second capacitor 4. In FIG. 3a, the second contact element 8′ of the second capacitor 4 is, for example, the center tap of the capacitor element 2.

The first capacitor 3 is separated and isolated from the second capacitor 4 by an insulation layer 16 of the first capacitor 3 and by an insulation layer 16′ of the second capacitor 4.

For all of the previously described embodiments, the first contact element 7 of the first capacitor 3 and the first contact element 7′ of the second capacitor 4 are both located on the first side of the capacitor element 2. Thus, the first contact element 7 of the first capacitor 3 and the first contact element 7′ of the second capacitor 4 are located on a common side of the capacitor assembly 1. The second contact element 8 of the first capacitor 3 and the second contact element 8′ of the second capacitor 4 are located on the second side 4 of the capacitor assembly 1. Thus, the second contact element 8 of the first capacitor 3 and the second contact element 8′ of the second capacitor 4 are located on a common side of the capacitor assembly 1. The second contact element 8 of the first capacitor 3 is formed in one piece with the second contact element 8′ of the second capacitor 4. The two second contact elements 8, 8′ can thus also be considered a single contact element or the second contact element 8 of the first capacitor 3 and the second contact element 8′ of the second capacitor 4 can be considered sections of a contact element of the capacitor element 2.

The second contact elements 8, 8′ may be utilized as the center tap of the capacitor element 2. However, it is advantageous if such a center tapping is located on the same side of the capacitor element 2, as well as its positive and negative terminal contact, which is achieved in FIG. 3a by the first contact element 7 of the first capacitor 3 and the first contact element 7′ of the second capacitor 4. A corresponding center tap is created by the capacitor elements 2 shown in FIGS. 3b to 3d.

FIG. 3b shows a capacitor element 2, which substantially corresponds to the capacitor element 2 known from FIG. 3a. The capacitor element 2 additionally comprises a first conductor element 9, which is located between the first capacitor 3 and the second capacitor 4. The first conductor element 9 has a substantially plate-like structure and is located in its plate plane parallel to the electrode layers 5, 6, 5′, 6′ of the capacitor element 2. Preferably, the first conductor element 9 has a shape that corresponds to an outer wall of the capacitors 3.4 in order to interlock with them. The first conductor element 9 is preferably formed in one piece with the second contact element 8 of the first capacitor 3 and the second contact element 8′ of the second capacitor 4. Thus, the second contact element 8 of the first capacitor 3 and the second contact element 8′ of the second capacitor 4 are connected on the second side to the first conductor element 9, wherein the second contact element 8 of the first capacitor 3 and the second contact element 8′ of the second capacitor 4 form a T shape together with the first conductor element 9. The first conductor element 9 extends into a plane on the first side of the capacitor element 2, in which the first contact elements 7, 7′ of the capacitors 3, 4 are also located. This allows a contacting of the second contact elements 8, 8′ of the first and second capacitors 3, 4 from the first side of the capacitor element 2 via the first conductor element 9. A center tap from the first side of the capacitor element 2 is thus enabled. Such a design of a center tap by means of the first conductor element 9 also results in the possibility of heat dissipation, through which heating caused by the capacitors 3, 4 can be dissipated from the otherwise poorly heat-conductive capacitor windings.

FIG. 3c shows an alternative realization of a center tap. The capacitor element 2 shown in FIG. 3c has substantially the same structure as the capacitor element 2 shown in FIG. 3a. However, in order to enable a center tap from the first side of the capacitor element 2, a second conductor element 10, 10′ is located on opposite sides of the capacitor element 2. The two second conductor elements 10, 10′ thus surround the capacitor element 2 due to these conductor elements being located on opposite sides of the first capacitor 3 and the second capacitor 4.

The two second conductor elements 10, 10′ have a substantially plate-like structure and are located in their panel plane parallel to the electrode layers 5, 5′, 6, 6′ of the two capacitors 3, 4 of the capacitor element 2 when the capacitors 3, 4 have a layered structure. If the capacitors 3, 4 have a wound structure, the two second conductor elements 10, 10′ extend parallel to a winding axis of the electrode layers 5, 5′, 6, 6′ of the two capacitors 3, 4.

The second conductor elements 10, 10′ are connected to the second contact element 8 of the first capacitor 3 and the second contact element 8′ of the second capacitor 4 on the second side, wherein the second conductor elements 10, 10′ are preferably formed in one piece with the two second contact elements 8, 8′ of the capacitors 3, 4 of the capacitor element 2. Thus, the second contact element 8 of the first capacitor 3 and the second contact element 8′ of the second capacitor 4 from a U shape together with the two second conductor elements 10, 10′. On the first side, the second conductor elements 10, 10′ extend into the plane in which the first contact elements 7, 7′ are located. Thus, via the second conductor elements 10, 10′, a contacting of the second contact elements 8, 8′ is enabled and thus a symmetrical center tap is created. Such an arrangement of the second conductor elements 10, 10′ additionally offers mechanical protection for the capacitors 3, 4 of the capacitor element 2 in addition to the improved heat dissipation.

FIG. 3d shows a capacitor assembly 1, which is substantially a combination of the capacitor assemblies 1 shown from FIGS. 3b and 3c. The capacitor assembly 1 shown in FIG. 3d comprises the first conductor element 9 and the two second conductor elements 10, 10′.

In the capacitor assemblies 1 described with FIGS. 3a to 3c, the first contact element 7 of the first capacitor 3 is located in a common plane with the first contact element 7′ of the second capacitor 4. The second contact element 8 of the first capacitor 3 is also located in a common plane with the second contact element 8′ of the second capacitor 4.

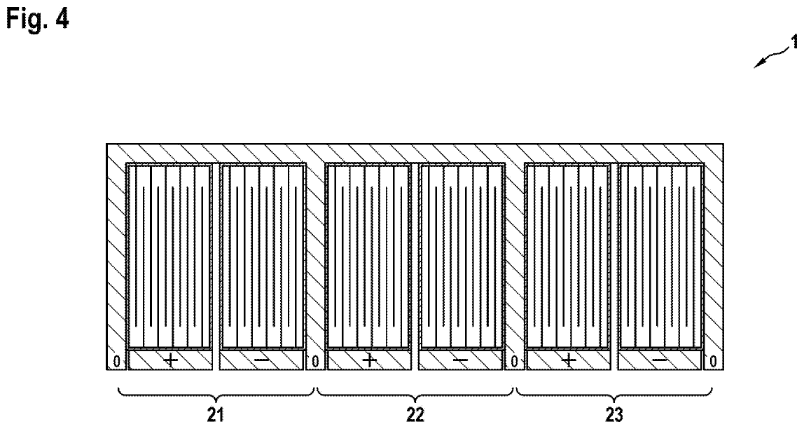

FIG. 4 shows a capacitor assembly 1 according to the invention, which comprises a plurality of capacitor elements 2. The capacitor assembly 1 with a plurality of capacitor elements 2 is in particular a combination of the capacitor elements 2 shown in FIGS. 3a to 3d. In FIG. 4, an exemplary combination of four of the capacitor elements 2 shown in FIG. 3c is depicted. It is noted that the second contact elements 8, 8′ can be formed in on piece with all capacitors 4, 5 of all capacitor elements 2. Depending on the consideration, the capacitor assembly 1 shown in FIG. 4 can also be considered a combination of the capacitor elements 2 shown in FIGS. 3a and 3c. The capacitor elements 2 of the capacitor assembly 1 shown in FIG. 4 are layered on top of one another. A stack of individual capacitor elements 2 is thus created, wherein a number of capacitor elements 2 being are located immediately adjacent to each other, wherein the capacitor elements 2 are located in a row.

The capacitor elements 2 are preferably layered, i.e. located side-by-side, such that the first capacitors 3 and the second capacitors 4 of the individual capacitor elements 2 are located alternately with respect to each other. Thus, in FIG. 4, a first capacitor 3 is firstly located, then a second capacitor 4, then a first capacitor 3 again, followed by a second capacitor 4, etc. This results in the magnetic fields extending outwards being compensated as much as possible and the effective inductance being minimized. The center tap of the capacitor assembly 1 can thereby be contacted at several locations from the first side of the capacitor assembly 1.

The first contact elements 7, 7′ of all capacitors 3 can also be contacted from the first side.

In order to provide a sufficient total capacity, the capacitor elements 2 are connected together to form a DC link capacitor. The entire DC link circuit therefore consists of a plurality of capacitor elements 2. By way of example, 3 cells are shown. However, the actual realized number may also be significantly higher. Preferably, the entire DC link circuit has as many cells as a motor associated with the entire DC link circuit has phases.

There are several parallel loops for each commutation case. Each commutation loop is reduced in its cross-sectional area because the back and forth paths are close to each other. The current distribution is thus more even and the effective inductance is lower.

For all capacitor assemblies 1 shown, it is preferred that they are configured for an operating voltage of more than 50V.

The capacitor assembly 1 according to the invention is particularly suitable for 3-level inverters in which center point tapping is required. Also, use in chargers for electric vehicles (in the vehicle or as a DC charging column), in drive inverters for electric vehicles with particularly high drive efficiency and in grid connections to stationary energy storage (e.g. battery) or power generators (e.g. fuel cells, photovoltaics) is advantageous.

In contrast to LIGA capacitors, it is therefore proposed to combine individual capacitor elements (e.g. from polypropylene films, PET films, PPS films, ceramic layers or in polymer multilayer technology). The structure should continue to be layered, but not on the electrode plane since this would not be useful for the desired voltage class (typically 300V-1000V), since higher voltages require greater spacing and care in the circuitry. The individual layer elements are created by the capacitors 3, 4 and are preferably configured for half the DC link voltage. The number of layers, i.e. the number of capacitor elements 2, is selected so as to achieve an optimum compromise of low inductance design, compact design and circuitry cost.

Since each layer is formed from a full-value capacitor, center point tapping can additionally be realized (versus LICA).

A capacitor element 2 preferably comprises a stack of electrodes from 1 mm to 100 mm of thickness. Too low stack heights create increased circuitry and insulation effort while too high stack heights reduce the advantages of the concept.

In addition to capacitor elements constructed in a layered form, round windings and, in particular, round windings that are pressed into flat form (“flat windings”) can also be used.

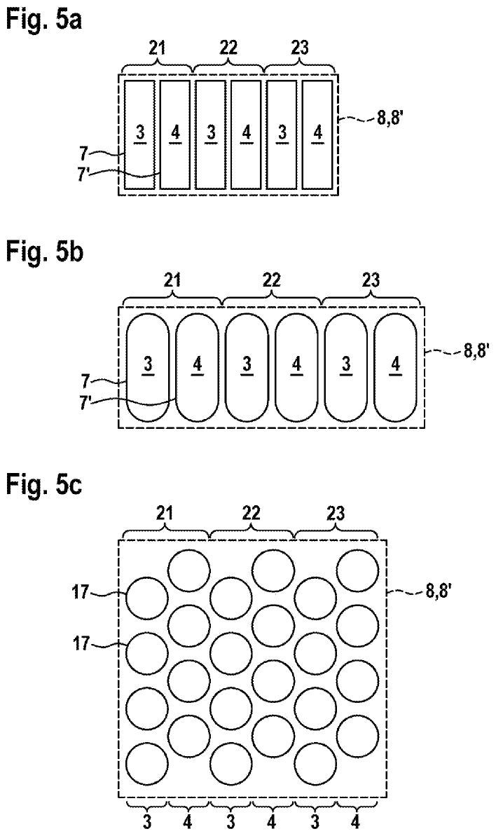

FIGS. 5a and 5b show the capacitor assembly 1 shown in FIG. 4 in a top view.

The capacitor assembly 1 is shown from the perspective of the first contact elements 7, 7′ located at the bottom in FIG. 4. FIG. 5a shows an arrangement of first capacitors 3 and second capacitors 4, which have a typical form for stacked capacitors. FIG. 5b shows arrangement of first capacitors 3 and second capacitors 4, which have a typical form for wound capacitors. The capacitors 3, 4 are flat-pressed round windings. The use of flat-pressed round windings reduces the area of the parallel plate guide somewhat, but this small disadvantage can often be accepted.

In both cases it can be seen that the first capacitors 3 can be contacted via the first contact elements 7 of the first capacitors 3 and the second capacitors 4 via the second contact elements 7′ of the second capacitors 4. At the same time, the second contact elements 8, 8′ can be contacted together via a contact element formed in one piece, which is located behind the capacitors 4, 5 in the image plane of FIGS. 5a and 5b. The conductor elements 10, 10′ shown in FIG. 4, by means of which the center tapping is enabled from the first side, are not shown in FIGS. 5a and 5b.

FIG. 5c shows a capacitor assembly 1, which substantially corresponds to the capacitor assemblies shown in FIGS. 5a and 5b, wherein the first capacitors 3 are, however, created from a parallel circuit of a plurality of wound capacitors 17, and wherein the second capacitors 4 are made from a parallel circuit of a plurality of wound capacitors 17. The round wound capacitors 17 of each first capacitor 3 are respectively contacted via a common first contact element 7 of the first capacitor 3. The round wound capacitors of each second capacitor 4 are respectively contacted via a common first contact element 7′ of the second capacitor 4. The winding axes of the round wound capacitors 17 of the first capacitors 3 are located, in the top view, such that they are offset from the winding axes of the round wound capacitors 17 of the second capacitors 4. The top view here is a view on the plane from the direction in which the winding axes are directed.

When using round windings, there is typically no parallelism between the layers of capacitors 3 and 4. Nevertheless, the alternating layers of the capacitor elements significantly improve the current distribution and effective inductance.

1. A capacitor assembly (1) comprising:
a capacitor element (2) including a first capacitor (3) and a second capacitor (4),
wherein the first capacitor (3) and the second capacitor (4) each have a layered or wound structure,
wherein a first electrode each can be contacted via a first contact element on a first side of each capacitor (3, 4),
wherein a second electrode each can be contacted via a second contact element on a second side of each capacitor (3, 4),
wherein the first contact element (7) of the first capacitor (3) and the first contact element (7′) of the second capacitor (4) are located on a common side of the capacitor assembly (1) corresponding to a first side,
wherein the second contact element (8) of the first capacitor (3) and the second contact element (8′) of the second capacitor (4) are located on a common side of the capacitor assembly (1) corresponding to a second side, and
wherein the second contact element (8) of the first capacitor (3) is electrically conductively connected to the second contact element (8′) of the second capacitor (4).

2. The capacitor assembly (1) according to claim 1, wherein the first capacitor (3) and the second capacitor (4) each have a first electrode layer (5, 5′) and a second electrode layer (6, 6′),
wherein the first electrode layer (5, 5′) projects over the second electrode layer (6, 6′) on the first side,
wherein the second electrode layer (6) projects over the first electrode layer (5, 5′) on the second side,
wherein the first electrode layer (5, 5′) is contacted on the first side via a first contact element (7, 7′), which rests on a face of the first electrode layer (5, 5′),
wherein the second electrode layer (6, 6′) is contacted on the second side via a second contact element (8, 8′), which rests on the face of the second electrode layer (6, 6′).

3. The capacitor assembly (1) according to claim 1, wherein the second contact element (8) of the first capacitor (3) is formed in one piece with the second contact element (8′) of the second capacitor (4).

4. The capacitor assembly (1) according to claim 1, wherein the capacitor element (2) further comprises a first conductor element (9), which
is located between the first capacitor (3) and the second capacitor (4),
is connected on the second side to the second contact element (8) of the first capacitor (3) and the second contact element (8′) of the second capacitor (4), and
allows contacting of the second contact elements (8, 8′) on the first side.

5. The capacitor assembly (1) according to claim 1, wherein the capacitor element (2) further comprises two second conductor elements (10, 10′), which
are located on opposite sides of the first capacitor (3) and the second capacitor (4),
are connected on the second side to the second contact elements (8) of the first capacitor (3) and the second contact element (8′) of the second capacitor (4), and
each allow contacting of the second contact elements (8, 8′) on the first side.

6. The capacitor assembly (1) according to claim 1,
wherein the first contact element (7) of the first capacitor (3) is located in a common plane with the first contact element (7′) of the second capacitor (4) and/or
wherein the second contact element (8) of the first capacitor (3) is located in a common plane with the second contact element (8′) of the second capacitor (4).

7. The capacitor assembly (1) according to claim 1,
wherein the first contact element (7) and the second contact elements (8) of the first capacitor (3) are located on opposite sides of the first capacitor (3), and
wherein the first contact element (7′) and the second contact element (8′) of the second capacitor (4) are located on opposite sides of the second capacitor (4).

8. The capacitor assembly (1) according to claim 1, wherein the capacitor assembly (1) has a plurality of capacitor elements (2), wherein the capacitor elements (2) are located such that the first capacitors (3) and the second capacitors (4) of the capacitor elements (2) are located alternately.

9. The capacitor assembly (1) according to claim 8, wherein the capacitor elements (2) are located in one plane, and the second contact elements (8, 8′) of all capacitor elements (2) are formed in one piece via a common contact element.

10. The capacitor assembly (1) according to claim 1,
wherein the capacitor assembly (1) is configured for an operating voltage of more than 50V.
